(19) United States
(12) Patent Application Publication
(10) Pub. No.: US 2024/0303983 A1
(43) Pub. Date: Sep. 12, 2024

(54) TECHNIQUES FOR MONOCULAR FACE CAPTURE USING A PERCEPTUAL SHAPE LOSS

(71) Applicants: DISNEY ENTERPRISES, INC., Burbank, CA (US); ETH Zürich (Eidgenössische Technische Hochschule Zürich), Zürich (CH)

(72) Inventors: Derek Edward BRADLEY, Zürich (CH); Prashanth CHANDRAN, Zürich (CH); Paulo Fabiano URNAU GOTARDO, Zürich (CH); Christopher Andreas OTTO, Zürich (CH); Gaspard ZOSS, Zürich (CH)

(21) Appl. No.: 18/599,021

(22) Filed: Mar. 7, 2024

Related U.S. Application Data
(60) Provisional application No. 63/489,152, filed on Mar. 8, 2023.

(51) Int. Cl. G06V 10/98; G06T 17/20; G06V 10/82

(52) U.S. Cl. CPC G06V 10/993; G06T 17/205; G06V 10/82

(57) ABSTRACT

One embodiment of the present invention sets forth a technique for evaluating three-dimensional (3D) reconstructions. The technique includes generating a 3D reconstruction of an object based on one or more mesh parameters. The technique also includes generating, based on the 3D reconstruction, a 3D rendering of the object. The technique further includes generating, using a machine learning model, a perceptual score associated with the 3D rendering and an input image of the object. The generated score represents how closely the 3D rendering matches the input image.

### CROSS-REFERENCE TO RELATED APPLICATIONS

This application claims benefit of the United States Provisional Patent Application titled “MONOCULAR FACE CAPTURE USING A PERCEPTUAL METRIC,” filed Mar. 8, 2023, and having Ser. No. 63/489,152. The subject matter of this related application is hereby incorporated herein by reference.

### BACKGROUND

### Field of the Various Embodiments

Embodiments of the present disclosure relate generally to machine learning and computer vision and, more specifically, to techniques for generating and evaluating three-dimensional (3D) renderings of two-dimensional (2D) representations of faces.

### Description of the Related Art

Generating a 3D reconstruction of a face from one or more 2D representations of the face is a common task in the fields of computer vision and computer graphics. Such reconstructions may be used in visual effects for, e.g., movies or television shows, computer games, social media, telepresence applications and virtual reality (VR) applications.

Existing techniques for generating 3D reconstructions of faces from 2D representations often require capturing multiple 2D representations of a single face using a predefined capture protocol. For example, a capture protocol may require multiple calibrated cameras capturing 2D representations of a face from several specified distances or viewpoints, under uniform lighting, and in a specified capture sequence.

One drawback of the above techniques is that they are not suitable for generating a 3D reconstruction from a single 2D representation (i.e., monocular face capture), or from multiple 2D representations that are not captured under controlled conditions using calibrated equipment and specified viewpoints as described above. As an example, such techniques may not be suitable for generating a 3D reconstruction of a user's face from a single image for use as an avatar in a social media application. As another example, imagery of a deceased actor may only be available as legacy footage (i.e., still images taken from previously captured video footage or a collection of photographs that were not captured under controlled conditions.) Techniques that require strictly controlled lighting, multiple cameras, or specific camera viewpoints may not be able to generate a 3D reconstruction of a face based on legacy footage.

Further, existing techniques for evaluating generated 3D reconstructions often compare a 3D rendering of the reconstructed geometry with one or more 2D representations used as inputs to the evaluation process. In evaluating 3D renderings, these techniques may perform pixel-by-pixel comparisons between a 3D rendering and a 2D representation and generate one or more metrics representing errors or misalignments in the comparisons, such as a mean squared error metric. The comparison may further be based on lighting or reflectance cues in the 3D rendering and 2D representation.

One drawback to the above techniques is that the evaluation of a 3D reconstruction of a face may be highly dependent on the specific model used to generate the 3D reconstruction. This model dependency may complicate the comparative evaluation of 3D reconstructions generated by a variety of different models. For example, pixel-by-pixel comparison metrics may depend on the specific topology of the 3D reconstruction, such as the number of vertices in the rendering or the coordinate system in which the reconstruction is generated. Likewise, an evaluation method that depends on lighting or reflectance cues in the 2D representation or 3D rendering may not be able to evaluate a 3D rendering produced by techniques that do not utilize these cues.

As the foregoing illustrates, what is needed in the art are more effective techniques for the generation and evaluation of a 3D reconstruction based on a single 2D representation of a face.

### SUMMARY

In one embodiment of the present invention, a technique for evaluating three-dimensional (3D) reconstructions includes generating a 3D reconstruction of an object based on one or more mesh parameters. The technique also includes generating, based on the 3D reconstruction, a 3D rendering of the object. The technique further includes generating, using a machine learning model, a perceptual score associated with the 3D rendering and an input image of the object. The generated score represents how closely the 3D rendering matches the input image.

One technical advantage of the disclosed techniques relative to the prior art is that the disclosed techniques generate a 3D reconstruction of a face from a single 2D representation of the face, rather than requiring multiple 2D representations captured under specific, controlled conditions. Further, the disclosed techniques generate quantitative perceptual evaluation scores for 3D renderings that are agnostic to the specific methods or models used to create the reconstructions, enabling meaningful comparisons of 3D reconstructions generated by different techniques. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 illustrates examples of an input image and a shaded 3D rendering, according to some embodiments.

FIG. 3 is a more detailed illustration of perceptual shape loss engine 122 of FIG. 1, according to some embodiments.

FIG. 4 is a flow diagram of method steps for training a critic network using a perceptual shape loss, according to various embodiments.

FIG. 5 is a more detailed illustration of rendering engine 124 of FIG. 1, according to some embodiments.

FIG. 6 is a more detailed illustration of an alternate embodiment of rendering engine 124 of FIG. 1.

FIG. 7 is a flow diagram of method steps for generating a 3D reconstruction, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

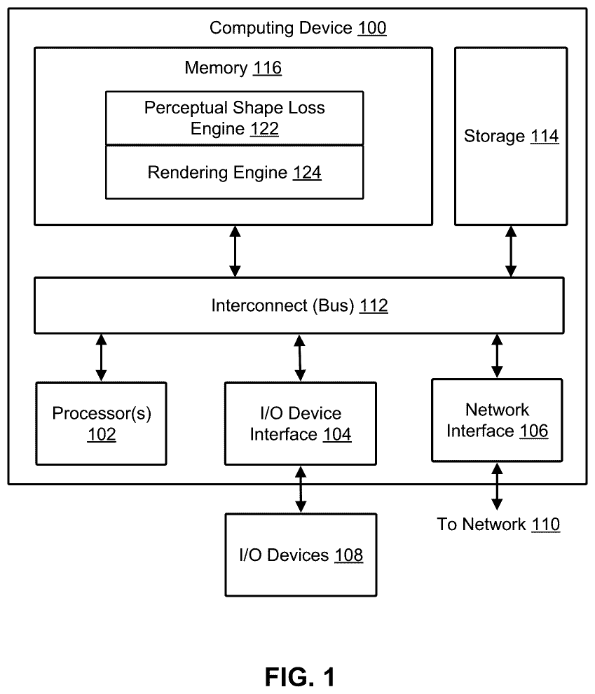

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a perceptual shape loss engine 122 and a rendering engine 124 that reside in a memory 116.

It is noted that the computing device described herein is illustrative and that any other technically feasible configurations fall within the scope of the present disclosure. For example, multiple instances of perceptual shape loss engine 122 and rendering engine 124 could execute on a set of nodes in a distributed and/or cloud computing system to implement the functionality of computing device 100. In another example, perceptual shape loss engine 122 and/or rendering engine 124 could execute on various sets of hardware, types of devices, or environments to adapt perceptual shape loss engine 122 and/or rendering engine 124 to different use cases or applications. In a third example, perceptual shape loss engine 122 and rendering engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Perceptual shape loss engine 122 and rendering engine 124 may be stored in storage 114 and loaded into memory 116 when executed.

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including perceptual shape loss engine 122 and rendering engine 124.

In some embodiments, perceptual shape loss engine 122 trains one or more machine learning models to perform perceptual evaluation of image-render pairs. Perceptual shape loss engine 122 trains the one or more machine learning models on a data set of labeled image-render pairs. Each image-render pair in the training set includes an image of a face, a shaded 3D rendering of a face, and a label identifying the image-render pair as “real” or “fake”. A real image-render pair includes a 3D rendering that matches both the identity and the facial expression of the associated image in the image-render pair. A fake image-render pair includes a 3D rendering that does not match one or more of the identity and facial expression of the associated image in the image-render pair. After training, the one or more trained machine learning models process an input image-render pair and generate a perceptual score for the image-render pair representing how accurately the 3D rendering matches the image.

In some embodiments, rendering engine 124 executes one or more trained machine learning models to generate a 3D rendering corresponding to an input image. Rendering engine 124 determines initial mesh parameters for a 3D renderer, and the 3D renderer generates a 3D rendering. A trained machine learning model analyzes the 3D rendering and an input image to generate a perceptual score associated with the 3D rendering and the input image. Based on the perceptual score, rendering engine 124 iteratively modifies one or more of the mesh parameters for the 3D renderer to optimize the perceptual score.

### Perceptual Shape Loss for 3D Renderings

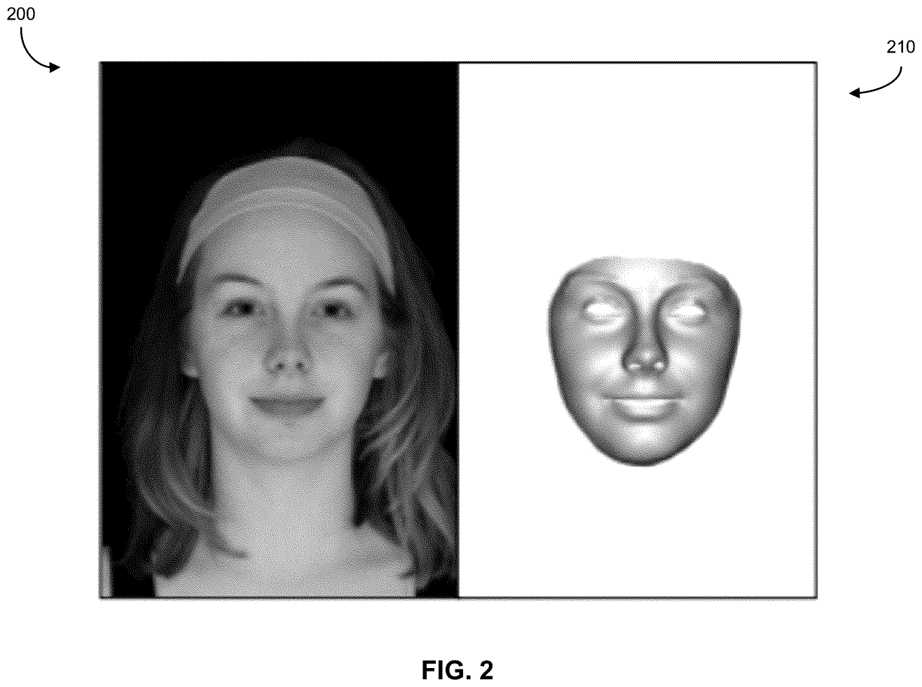

FIG. 2 illustrates an example of an image-render pair including an image and a shaded 3D rendering, according to some embodiments. As shown, the image-render pair includes image 200 and shaded 3D rendering 210. In various embodiments, image 200 may be an RGB image or a grayscale image.

Image 200 depicts a specific individual's face and a facial expression associated with the face (for example, performed by the face). Thus, image 200 includes both an identity and an expression. In various embodiments, image 200 is a rasterized representation including a two-dimensional arrangement of pixels.

Shaded 3D rendering 210 depicts a shaded 3D rendering of a human face generated based on an RGB image. A shaded 3D rendering includes both a representation of a 3D geometry and color variations based on a single point light in front of the face and an estimated camera position. In some embodiments, shaded 3D rendering 210 is a rasterized representation of a three-dimensional geometry and includes a two-dimensional arrangement of pixels.

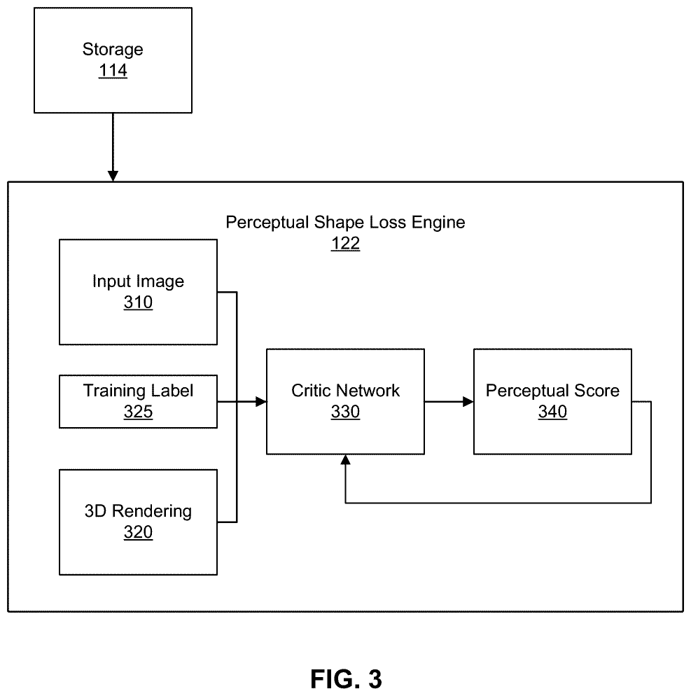

As discussed below in greater detail in the description of FIG. 3, a combination of an image 200 and a shaded 3D rendering 210 form an image-render pair. A data set may include one or more real or fake image-render pairs. A real image-render pair includes an image 200 and a shaded 3D rendering 210 that matches both the identity and facial expression included in image 200. A fake image-render pair includes an image 200 and a shaded 3D rendering 210 that fails to match at least one of the identity or facial expression included in image 200.

FIG. 3 is a more detailed illustration of perceptual shape loss engine 122 of FIG. 1, according to some embodiments. Perceptual shape loss engine 122 trains a critic network 330 to generate a perceptual score 340 associated with an input image 310 and a 3D rendering 320. As shown, perceptual shape loss engine 122 further includes training label 325.

Perceptual shape loss engine 122 processes a data set of labeled image-render pairs to train critic network 330. In some embodiments, perceptual shape loss engine 122 may receive labeled image-render pairs from a data set stored in, e.g., storage 114 as shown.

Perceptual shape loss engine 122 receives an image-render pair from a data set included in storage 114. The image-render pair includes input image 310. input image 310 depicts a specific individual's face and an associated facial expression. Thus, input image 310 includes both an identity and an expression. input image 310 is a rasterized representation including a two-dimensional arrangement of pixels.

The image-render pair also includes 3D rendering 320 depicting a shaded 3D rendering of a human face including a facial expression, generated based on an image. In some embodiments, 3D rendering 320 is a rasterized representation of a three-dimensional geometry and includes a two-dimensional arrangement of pixels. 3D rendering 320 includes both an identity and a facial expression determined by the image from which 3D rendering 320 was generated.

An image-render pair further includes an associated training label 325. In various embodiments, training label 325 associated with a particular image-render pair has an associated value of “real” or “fake.” A training label 325 having an associated value of “real” indicates a real image-render pair that includes an input image 310 and a 3D rendering 320 for which both the identities and expressions match. A training label 325 having an associated value of “fake” indicates a fake image-render pair that includes an input image 310 and a 3D rendering 320 for which one or both of the identity and expression of 3D rendering 320 do not match the corresponding identity or expression of input image 310.

In various embodiments, perceptual shape loss engine 122 may pre-process input image 310 and 3D rendering 320 by cropping and aligning the eyes, mouth and nose depicted in input image 310 and 3D rendering 320 to the same approximate position. Perceptual shape loss engine 122 may also remove portions of 3D rendering 320 that are greater than a calculated distance away from the center of the 3D rendering. Perceptual shape loss engine 122 may also replace the background of 3D rendering 320 with a random or pseudo-random noise pattern.

Perceptual shape loss engine 122 trains critic network 330 to generate perceptual score 340. In various embodiments, critic network 330 is a machine learning model, such as a discriminator-style convolutional neural network. Critic network 330 includes one or more trainable parameters [symbol] .

For a given image-render pair, critic network 330 generates scalar perceptual score 340. In various embodiments, perceptual shape loss engine 122 may normalize perceptual score 340 to a value between −1 and 1, inclusive. During training, perceptual shape loss engine 122 iteratively modifies the one or more trainable parameters [symbol] of critic network 330, such that perceptual score 340 is maximized for real image-render pairs in the data set and minimized for fake image-render pairs in the data set. Perceptual shape loss engine 122 iteratively modifies the one or more trainable parameters [symbol] of critic network 330 based on the critic loss function:

$${ℒ}_{critic} = 𝒟 ( \tilde{x} ) - 𝒟 ( x ) + {λ ( {‖ {∇}_{\tilde{x}} 𝒟 ( \hat{x} ) ‖}_{2} - 1 )}^{2} \qquad ( 1 )$$

In Equation (1) above, [symbol] represents the one or more trainable parameters of critic network 330, x is a real image-render pair, \tilde{x} is a fake image-render pair, λ(∥∇_{\tilde{x}} [symbol] (\hat{x})∥₂−1)² is a gradient penalty term that encourages the gradient norm ∥∇_{\tilde{x}} [symbol] (\hat{x})∥₂ to remain close to 1, where \hat{x}=ϵx+(1−ϵ)\tilde{x}, and ϵ is a random number drawn from a uniform distribution between 0 and 1.

Perceptual shape loss engine 122 trains critic network 330 on a predetermined number of real and fake image-render pairs included in the data set. Perceptual shape loss engine 122 evaluates trained critic network 330 on a validation set of labeled image-render pairs included in the data set. Perceptual shape loss engine 122 evaluates how well critic network 330 separates real image-render pairs included in the validation set from fake image-render pairs included in the validation set. Specifically, critic network 330 should generate generally higher perceptual scores 340 for real image-render pairs compared to the perceptual scores 340 generated for fake image-render pairs. If perceptual shape loss engine 122 determines that critic network 330 adequately separates real and fake image-render pairs based on the generated perceptual scores 340 associated with the validation set, perceptual shape loss engine 122 terminates training and stores the trained critic network 330. For example, perceptual shape loss engine 122 may determine a percentage of real image-render pairs in the validation set for which critic network 330 generated a perceptual score 340 that is higher than the highest perceptual score 340 generated for any of the fake image-render pairs in the validation set. If the determined percentage is greater than a predetermined threshold percentage, perceptual shape loss engine 122 determines that critic network 330 adequately separates real and fake image render pairs in the validation set. In some embodiments, perceptual shape loss engine 122 may store trained critic network 330 in storage 114. If perceptual shape loss engine 122 determines that critic network 330 does not adequately separate real and fake image-render pairs based on the generated perceptual scores 340, perceptual shape loss engine 122 continues training critic network 330 on additional image-render pairs included in the data set.

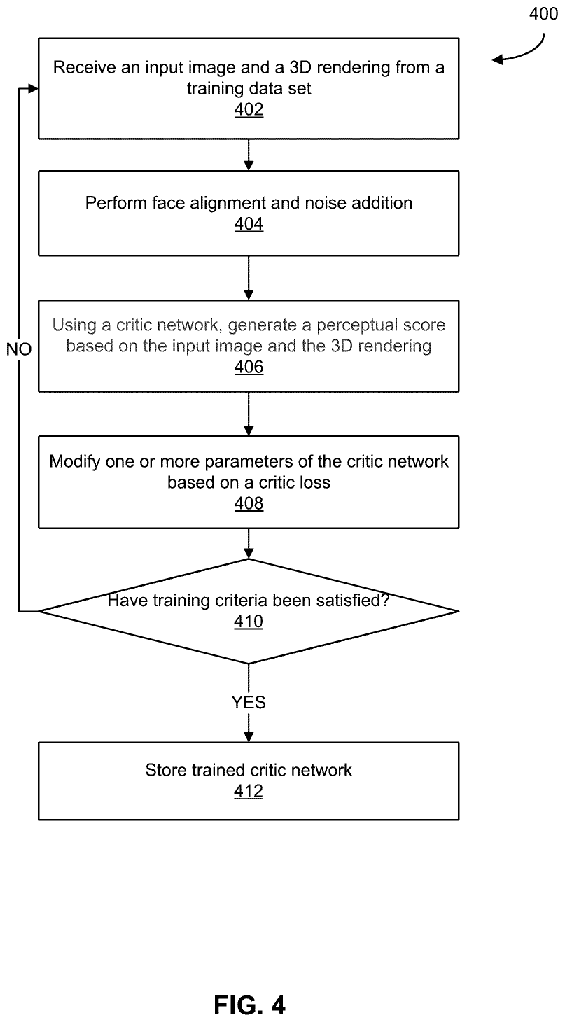

FIG. 4 is a flow diagram of method steps for training a critic network using the critic loss function from Equation (1), according to various embodiments. Although the method steps are described in conjunction with the systems of FIGS. 1-3, persons skilled in the art will understand that any system configured to perform the method steps in any order falls within the scope of the present disclosure.

As shown, in operation 402 of method 400, perceptual shape loss engine 122 receives an image-render pair including an input image and a 3D rendering from a training data set. The image-render pair also includes a training label indicating whether the image-render pair is “real” or “fake,” as discussed above in the description of FIG. 3.

In operation 404, perceptual shape loss engine 122 crops and aligns the eyes, mouth and nose depicted in input image 310 and 3D rendering 320 to the same approximate positions. Perceptual shape loss engine 122 may also remove portions of 3D rendering 320 that are greater than a calculated distance away from the center of the 3D rendering and replace the background of 3D rendering 320 with a random or pseudo-random pattern of noise.

In operation 406, perceptual shape loss engine 122 transmits the image-render pair including input image 310 and 3D rendering 320 to critic network 330. Critic network 330 calculates a critic loss function [symbol] _{critic} associated with the image-render pair according to Equation (1) above. Critic network 330 also generates a perceptual score 340 associated with the image-render pair representing how well 3D rendering 320 matches input image 310.

In operation 408, perceptual shape loss engine 122 modifies one or more parameters [symbol] of critic network 330 based on the critic loss function. Perceptual shape loss engine 122 modifies the one or more parameters [symbol] such that perceptual score 340 is maximized for real image-render pairs in the data set and minimized for fake image-render pairs in the data set.

In operation 410, perceptual shape loss engine 122 determines if predetermined training criteria have been satisfied. In various embodiments, the training criteria may include an evaluation of how well critic network 330 separates real and fake image-render pairs included in a validation data set as described above in the discussion of FIG. 3. If perceptual shape loss engine 122 determines that the training criteria have been satisfied, method 400 proceeds to operation 412, where perceptual shape loss engine 122 stores the trained critic network in, e.g. storage 114. If perceptual shape loss engine 122 determines that the training criteria have not been satisfied, the method returns to step 402 and perceptual shape loss engine 122 receives an additional image-render pair from the training data set.

### 3D Rendering Generation

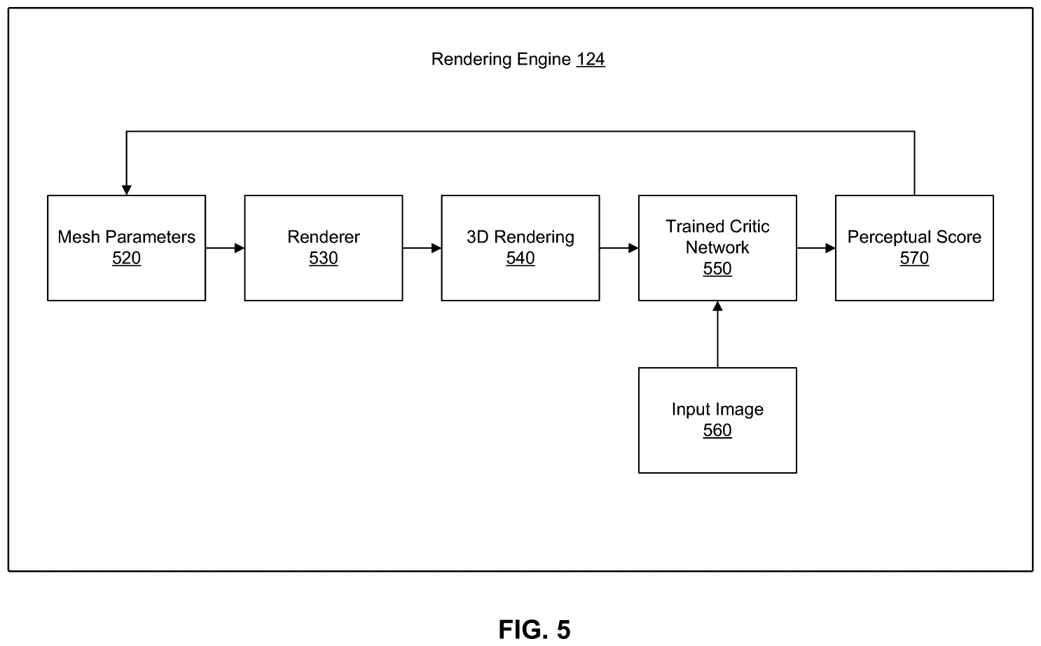

FIG. 5 is a more detailed illustration of rendering engine 124 of FIG. 1, according to some embodiments. Rendering engine 124 generates a 3D rendering 540 based on an input image 560. As shown, rendering engine 124 also includes mesh parameters 520, renderer 530, trained critic network 550, and perceptual score 570.

Mesh parameters 520 include one or more modifiable parameters that direct renderer 530 in the generation of a 3D rendering 540. In various embodiments, mesh parameters are associated with one or more of an identity, expression, or head pose in generated 3D rendering 540. During operation, rendering engine 124 transmits mesh parameters 520 to renderer 530. Rendering engine 124 may initialize mesh parameters 520 based on random and/or predetermined values.

Renderer 530 generates 3D rendering 540 based on mesh parameters 520. In some embodiments, renderer 530 may be a machine learning model such as a neural network. Renderer 530 may generate a 3D rendering 540 that includes any suitable number of polygons and vertices, as well as shading information associated with the polygons and/or vertices.

3D rendering 540 is a representation of a 3D geometry based on mesh parameters 520. As discussed above, 3D rendering 540 may include any number of vertices and polygons as well as associated shading information. In various embodiments, rendering engine 124 may convert 3D rendering 540 from a collection of polygons and vertices into a rasterized rendering including a two-dimensional arrangement of pixels. In various embodiments, rendering engine 124 may also crop and/or align portions of 3D rendering 540 to input image 560 discussed below and replace the background of 3D rendering 540 with a random or pseudo-random pattern of noise.

Input image 560 is a representation of an individual's face, including a facial expression. Input image 560 includes a two-dimensional arrangement of pixels. As discussed above, rendering engine 124 may crop and/or align portions of input image 560 with corresponding portions of 3D rendering 540.

Trained critic network 550 is a machine learning model that has been trained to generate a perceptual score for an image-render pair, as discussed above in the descriptions of FIGS. 3 and 4. In various embodiments, trained critic network 550 is a discriminator-style convolutional neural network. Rendering engine 124 transmits 3D rendering 540 and input image 560 to trained critic network 550. Trained critic network 550 analyzes 3D rendering 540 and input image 560 and generates a perceptual score 570.

Perceptual score 570 represents how well 3D rendering 540 matches input image 560. In some embodiments, trained critic network 550 generates a value of perceptual score 570 that is above a threshold to indicate a close match between 3D rendering 540 and input image 560. Trained critic network 550 may generate a score that is below a threshold to indicate that 3D rendering 540 does not closely match input image 560. Based on perceptual score 570, rendering engine 124 iteratively modifies mesh parameters 520, generates a new 3D rendering 540, and transmits the new 3D rendering 540 to trained critic network 550 for evaluation. Rendering engine 124 continues this iterative modification until perceptual score 570 is optimized. In various embodiments, perceptual score 570 is optimized when perceptual score 570 reaches a locally maximal value, reaches a predetermined threshold value, or when the rate of change of perceptual score 570 drops below a predetermined value. When rendering engine 124 has optimized perceptual score 570, rendering engine 124 stores and/or outputs the generated 3D rendering 540.

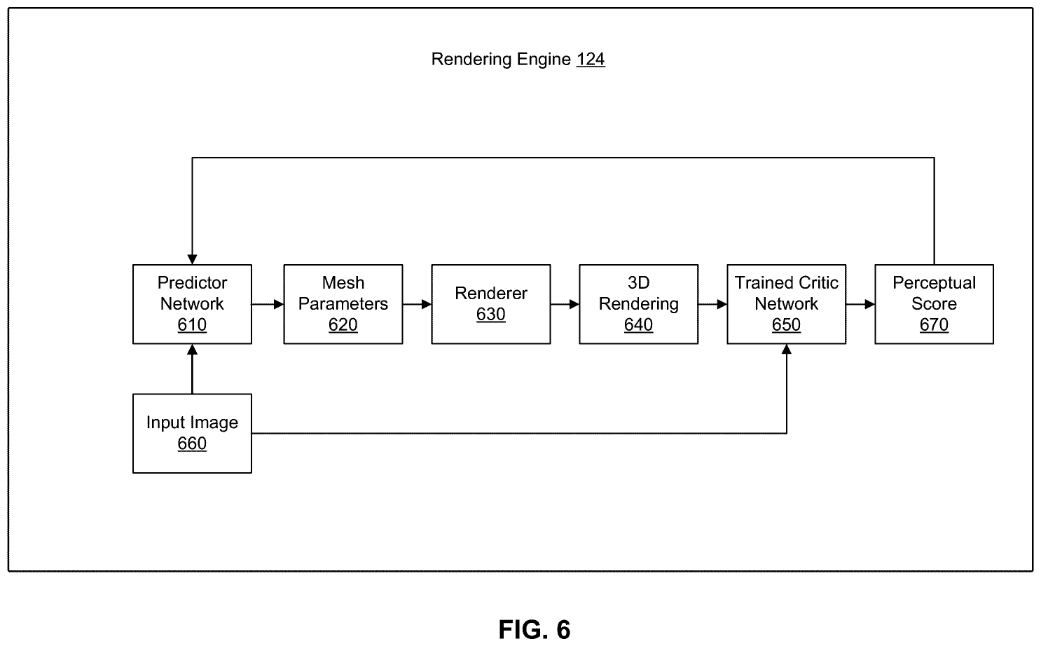

FIG. 6 is a more detailed illustration of an alternate embodiment of rendering engine 124 of FIG. 1. The operation of this alternate embodiment is similar to that discussed above in the description of FIG. 5, except that rather than modifying one or more mesh parameters 620 directly, rendering engine 124 modifies one or more parameters associated with a predictor network 610. As shown, rendering engine 124 also includes input image 660, renderer 630, 3D rendering 640, trained critic network 650, and perceptual score 670.

Predictor network 610 generates mesh parameters 620 based on an input image 660. In various embodiments, predictor network may be any suitable machine learning model that, for a given image, generates mesh parameters that define a 3D representation associated with the image, the representation including a set of vertices and polygons defined by the vertices. Predictor network 610 includes one or more modifiable parameters. In various embodiments, rendering engine 124 may initialize the parameters of predictor network.

Mesh parameters 620 include a set of vertices and polygons that define a 3D representation. During operation, rendering engine 124 transmits mesh parameters 620 to renderer 630. Renderer 630 generates 3D rendering 640 based on mesh parameters 620. In some embodiments, renderer 630 may be a machine learning model such as a neural network. Renderer 630 may generate a 3D rendering 640 that includes any suitable number of polygons and vertices, as well as shading information associated with the polygons and/or vertices.

3D rendering 640 is a representation of a 3D geometry based on mesh parameters 620. As discussed above, 3D rendering 640 may include any number of vertices and polygons as well as associated shading information. In various embodiments, rendering engine 124 may convert 3D rendering 640 from a collection of polygons and vertices into a rasterized rendering including a two-dimensional arrangement of pixels. In various embodiments, rendering engine 124 may also crop and/or align portions of 3D rendering 640 to input image 660 discussed below and replace the background of 3D rendering 640 with a random or pseudo-random pattern of noise.

Input image 660 is an RGB or grayscale representation of an individual's face, including a facial expression. Input image 660 includes a two-dimensional arrangement of pixels. As discussed above, rendering engine 124 may crop and/or align portions of input image 660 with corresponding portions of 3D rendering 640. Rendering engine 124 transmits input image 660 to both predictor network 610 and trained critic network 650.

Trained critic network 650 is a machine learning model that has been trained to generate a perceptual score for an image-render pair, as discussed above in the descriptions of FIGS. 3 and 4. In various embodiments, trained critic network 650 is a discriminator-style convolutional neural network. Rendering engine 124 transmits 3D rendering 640 and input image 660 to trained critic network 650. Trained critic network 650 analyzes 3D rendering 640 and input image 660 and generates a perceptual score 670.

Perceptual score 670 represents how well 3D rendering 640 matches input image 660. In some embodiments, trained critic network 650 generates a value of perceptual score 670 that is above a threshold to indicate a close match between 3D rendering 640 and input image 660. Trained critic network 650 may generate a value of perceptual score 670 that is below a threshold to indicate that 3D rendering 640 does not closely match input image 660. Based on perceptual score 670, rendering engine 124 iteratively modifies the parameters of predictor network 610, generates a new 3D rendering 640, and transmits the new 3D rendering 640 to trained critic network 650 for evaluation. Rendering engine 124 continues this iterative modification until perceptual score 670 is optimized. In various embodiments, perceptual score 670 is optimized when perceptual score 670 reaches a locally maximal value, reaches a predetermined threshold value, or when the rate of change of perceptual score 670 drops below a predetermined value. When rendering engine 124 has optimized perceptual score 670, rendering engine 124 stores and/or outputs the generated 3D rendering 640.

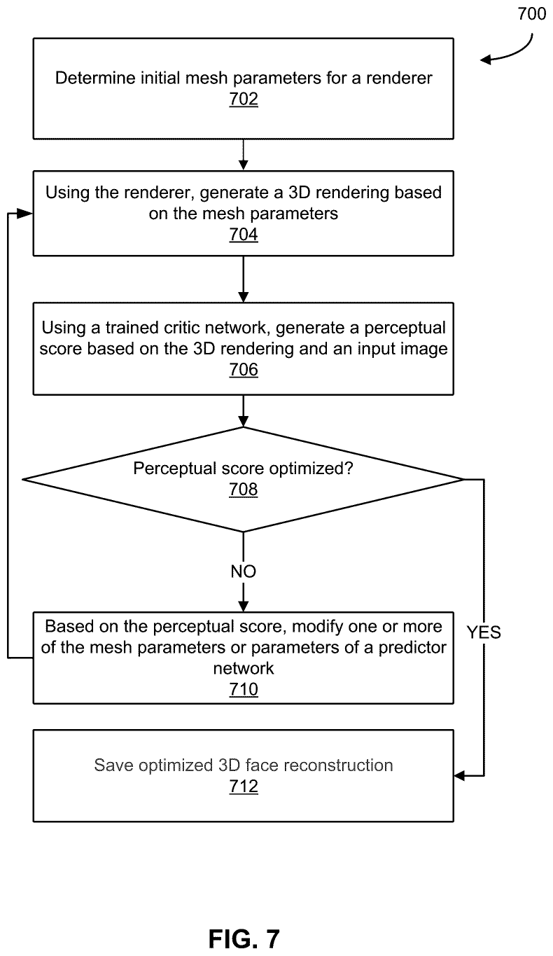

FIG. 7 is a flow diagram of method steps for generating a 3D rendering, according to various embodiments. Although the method steps are described in conjunction with the systems of FIGS. 1-2 and 5-6, persons skilled in the art will understand that any system configured to perform the method steps in any order falls within the scope of the present disclosure.

As shown, in operation 702 of method 700, rendering engine 124 determines initial mesh parameters for a differentiable renderer. As discussed above in reference to FIG. 5, rendering engine 124 may directly initialize mesh values 520. In other embodiments such as the embodiment discussed in the description of FIG. 6, rendering engine 124 may initialize parameter values of a predictor network 610. Predictor network 610, in turn, initializes mesh values 620.

In operation 704, rendering engine 124 transmits the mesh parameters 520 to renderer 530, and renderer 530 generates a 3D rendering 540 based on mesh parameters 520. In various embodiments, rendering engine 124 may also crop and/or align portions of 3D rendering 540 to input image 560 and replace the background of 3D rendering 540 with a random or pseudo-random pattern of noise.

In operation 706, rendering engine 124 transmits 3D rendering 540 and input image 560 to trained critic network 550. Trained critic network 550 generates a perceptual score 570 that represents how well 3D rendering 540 matches input image 560. In some embodiments, trained critic network 550 generates a value of perceptual score 570 that is above a threshold to indicate a close match between 3D rendering 540 and input image 560. Trained critic network 550 may generate a value of perceptual score 570 that is below a threshold to indicate that 3D rendering 540 does not closely match input image 560.

In operation 708, rendering engine 124 determines whether perceptual score 708 is optimized. In various embodiments, perceptual score 570 is optimized when perceptual score 570 reaches a locally maximal value, reaches a predetermined threshold value, or when the rate of change of perceptual score 570 over several iterations drops below a predetermined value. When rendering engine 124 has optimized perceptual score 570, method 700 proceeds to step 712 and rendering engine 124 stores and/or outputs the generated 3D rendering 540.

In operation 710, if rendering engine 124 determines that perceptual score 570 has not yet been optimized, rendering engine modifies either mesh parameters 520 as discussed above in the description of FIG. 5 or the parameters of predictor network 610 as discussed above in the description of FIG. 6. After modifying mesh parameters 520 or the parameters of predictor network 610, the method returns to step 704 to generate a new 3D rendering based on the modified mesh parameters, or the mesh parameters initialized by the predictor network based on the modified parameters of the predictor network.

In sum, a perceptual shape loss engine processes an input image of a face and a corresponding 3D rendering to generate a perceptual shape loss representing how accurately the 3D rendering represents the geometry of the input image. The perceptual shape loss engine includes a critic network, for example a discriminator-style neural network. The perceptual shape loss engine trains the critic network on a training data set of image-render pairs. The training data set includes both real and fake image-render pairs. A real image-render pair includes an image of a specific individual's face depicting a facial expression and a 3D rendering that correctly depicts both the individual and the facial expression. Thus, in a real image-render pair, both the identity and the expression match between the image and the 3D rendering. A fake image-render pair includes an image and a 3D rendering in which one or more of the identity or the facial expression do not match between the image and the 3D rendering. For example, a fake image-render pair may include an image and a rendering of the same individual, but with different expressions. As another example, a fake image-render pair may include an image of one individual and a rendering of a different individual, both the image and the rendering depicting the same facial expression. As yet another example, a fake image-render pair may include an image depicting one individual and facial expression and a rendering depicting a different individual and a different facial expression. Based on a critic loss calculated from the critic network outputs for the image-render pairs in the training data set, the perceptual shape loss engine adjusts the parameters of the critic network. The perceptual shape loss engine evaluates the critic network on a testing data set of image-render pairs and stores the trained critic network.

A rendering engine generates a 3D rendering for an input image (e.g., an RGB image or a grayscale image) based on a perceptual score generated by the trained critic network. In various embodiments, the rendering engine may iteratively adjust the mesh parameters of a differentiable renderer based on the perceptual score generated by the trained critic network. In other embodiments, the rendering engine may iteratively adjust the parameters of a predictor network that generates mesh parameters for input into the differentiable renderer.

One technical advantage of the disclosed techniques relative to the prior art is that the disclosed techniques generate a 3D reconstruction of a face from a single 2D representation of the face, rather than requiring multiple 2D representations captured under specific, controlled conditions. Further, the disclosed techniques generate quantitative perceptual evaluation scores for 3D renderings that are agnostic to the specific methods or models used to create the reconstructions, enabling meaningful comparisons of 3D renderings generated by different techniques. These technical advantages provide one or more technological improvements over prior art approaches.
1. In some embodiments, a computer-implemented method for evaluating three-dimensional (3D) reconstructions comprises generating, based on one or more mesh parameters, a 3D reconstruction of an object, generating, based on the 3D reconstruction, a 3D rendering of the object, and generating, using a machine learning model, a perceptual score associated with the 3D rendering and an input image of the object, wherein the perceptual score represents how closely the 3D rendering matches the input image.
2. The computer-implemented method of clause 1, the computer-implemented method further comprising modifying, based on the perceptual score, at least one of the one or more mesh parameters, and generating, based on the modified one or more mesh parameters, a second 3D rendering.
3. The computer-implemented method of clauses 1 or 2, further comprising repeatedly modifying the at least one of the one or more of the mesh parameters during a plurality of iterations.
4. The computer-implemented method of any of clauses 1-3, further comprising determining, during the plurality of iterations, a locally maximal value for the perceptual score or a rate of change associated with the perceptual score.
5. The computer-implemented method of any of clauses 1-4, wherein modifying the at least one of the one or more the mesh parameters comprises modifying parameters of a predictor network.
6. The computer-implemented method of any of clauses 1-5, wherein the machine learning model is a discriminator-type neural network.
7. The computer-implemented method of any of clauses 1-6, wherein the object of the input image comprises a face, and the input image includes an identity and a facial expression.
8. The computer-implemented method of any of clauses 1-7, wherein the one or more mesh parameters are associated with at least one of an identity, expression, or head pose.
9. The computer-implemented method of any of clauses 1-8, wherein the 3D rendering includes shading information based on a single point light in front of the object and an estimated camera position.
10. In some embodiments, a computer-implemented method for training a machine learning model to evaluate three-dimensional (3D) renderings, the computer-implemented method comprises generating, using a machine learning model, a perceptual score based on a 3D rendering of an object and an input image of the object, wherein the perceptual score indicates a degree to which the 3D rendering does not match the input image, generating a critic loss based on the perceptual score, and modifying one or more parameters of the machine learning model based on the critic loss.
11. The computer-implemented method of clause 10, wherein the machine learning model is a discriminator-type neural network.
12. The computer-implemented method of clauses 10 or 11, wherein the object comprises a face, and the input image includes an identity and a facial expression.
13. The computer-implemented method of any of clauses 10-12, wherein the 3D rendering includes a second identity and a second facial expression, and at least one of the identity or the facial expression included in the input image do not match the second identity or the second facial expression included in the 3D rendering.
14. The computer-implemented method of any of clauses 10-13, wherein the 3D rendering includes a second identity and a second facial expression, the identity included in the input image matches the second identity included in the 3D rendering, and the facial expression included in the input image matches the second facial expression included in the 3D rendering.
15. The computer-implemented method of any of clauses 10-14, wherein the 3D rendering is a rasterized representation that includes a two-dimensional (2D) arrangement of pixels.
16. The computer-implemented method of any of clauses 10-15, further comprising repeatedly modifying the one or more parameters of the machine learning model during a plurality of iterations.
17. The computer-implemented method of any of clauses 10-16, further comprising evaluating the machine learning model on a plurality of image-render pairs included in a validation set of image-render pairs.
18. In some embodiments, a system comprises one or more memories storing instructions, and one or more processors for executing the instructions to generate, based on one or more mesh parameters, a 3D reconstruction of an object, generate, based on the 3D reconstruction, a 3D rendering of the object, and generate, using a machine learning model, a perceptual score associated with the 3D rendering and an input image of the object, wherein the perceptual score represents how closely the 3D rendering matches the input image.
19. The system of clause 18, wherein the machine learning model is a discriminator-type neural network.
20. The system of clauses 18 or 19, wherein the object of the input image comprises a face, and the input image includes an identity and a facial expression.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can include or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for evaluating three-dimensional (3D) reconstructions, the computer-implemented method comprising:
generating, based on one or more mesh parameters, a 3D reconstruction of an object;
generating, based on the 3D reconstruction, a 3D rendering of the object; and
generating, using a machine learning model, a perceptual score associated with the 3D rendering and an input image of the object, wherein the perceptual score represents how closely the 3D rendering matches the input image.

2. The computer-implemented method of claim 1, the computer-implemented method further comprising:
modifying, based on the perceptual score, at least one of the one or more mesh parameters, and
generating, based on the modified one or more mesh parameters, a second 3D rendering.

3. The computer-implemented method of claim 2, further comprising repeatedly modifying the at least one of the one or more of the mesh parameters during a plurality of iterations.

4. The computer-implemented method of claim 3, further comprising determining, during the plurality of iterations, a locally maximal value for the perceptual score or a rate of change associated with the perceptual score.

5. The computer-implemented method of claim 2, wherein modifying the at least one of the one or more the mesh parameters comprises modifying parameters of a predictor network.

6. The computer-implemented method of claim 1, wherein the machine learning model is a discriminator-type neural network.

7. The computer-implemented method of claim 1, wherein the object of the input image comprises a face, and the input image includes an identity and a facial expression.

8. The computer-implemented method of claim 1, wherein the one or more mesh parameters are associated with at least one of an identity, expression, or head pose.

9. The computer-implemented method of claim 1, wherein the 3D rendering includes shading information based on a single point light in front of the object and an estimated camera position.

10. A computer-implemented method for training a machine learning model to evaluate three-dimensional (3D) renderings, the computer-implemented method comprising:
generating, using a machine learning model, a perceptual score based on a 3D rendering of an object and an input image of the object, wherein the perceptual score indicates a degree to which the 3D rendering does not match the input image;
generating a critic loss based on the perceptual score, and
modifying one or more parameters of the machine learning model based on the critic loss.

11. The computer-implemented method of claim 10, wherein the machine learning model is a discriminator-type neural network.

12. The computer-implemented method of claim 10, wherein the object comprises a face, and the input image includes an identity and a facial expression.

13. The computer-implemented method of claim 12, wherein the 3D rendering includes a second identity and a second facial expression, and at least one of the identity or the facial expression included in the input image do not match the second identity or the second facial expression included in the 3D rendering.

14. The computer-implemented method of claim 12, wherein the 3D rendering includes a second identity and a second facial expression, the identity included in the input image matches the second identity included in the 3D rendering, and the facial expression included in the input image matches the second facial expression included in the 3D rendering.

15. The computer-implemented method of claim 10, wherein the 3D rendering is a rasterized representation that includes a two-dimensional (2D) arrangement of pixels.

16. The computer-implemented method of claim 10, further comprising repeatedly modifying the one or more parameters of the machine learning model during a plurality of iterations.

17. The computer-implemented method of claim 10, further comprising evaluating the machine learning model on a plurality of image-render pairs included in a validation set of image-render pairs.

18. A system comprising:
one or more memories storing instructions; and
one or more processors for executing the instructions to:
generate, based on one or more mesh parameters, a 3D reconstruction of an object;
generate, based on the 3D reconstruction, a 3D rendering of the object; and
generate, using a machine learning model, a perceptual score associated with the 3D rendering and an input image of the object, wherein the perceptual score represents how closely the 3D rendering matches the input image.

19. The system of claim 18, wherein the machine learning model is a discriminator-type neural network.

20. The system of claim 18, wherein the object of the input image comprises a face, and the input image includes an identity and a facial expression.
